(19) United States
(12) Patent Application Publication
(10) Pub. No.: US 2026/0208167 A1
(43) Pub. Date: Jul. 23, 2026

(54) CATALYSTS FOR REVERSE WATER GAS SHIFT REACTIONS

(71) Applicant: SAUDI ARABIAN OIL COMPANY, Dhahran (SA)

(72) Inventors: Mohammed A. AL-DAOUS, Dhahran (SA); Khaled NAFEE, Dhahran (SA); Mohammed R. ALALOUNI, Dhahran (SA)

(73) Assignee: SAUDI ARABIAN OIL COMPANY, Dhahran (SA)

(21) Appl. No.: 19/034,937

(22) Filed: Jan. 23, 2025

(51) Int. Cl. B01J 23/78; B01J 21/06; B01J 37/02; B01J 37/08; C01B 32/40

(52) U.S. Cl. CPC B01J 23/78; B01J 21/066; B01J 37/0205; B01J 37/08; C01B 32/40

(57) ABSTRACT

Embodiments include catalysts that include a zirconium doped aluminum support, the zirconium being present in 0.5 wt % to 4 wt % based on the weight of the support, 3 wt % to 20 wt % iron, the weight percent being based on the combined weight of the zirconium doped support and the iron; and 1 wt % to 10 wt % alkali metal, the weight percent being based on the total weight of the catalyst.

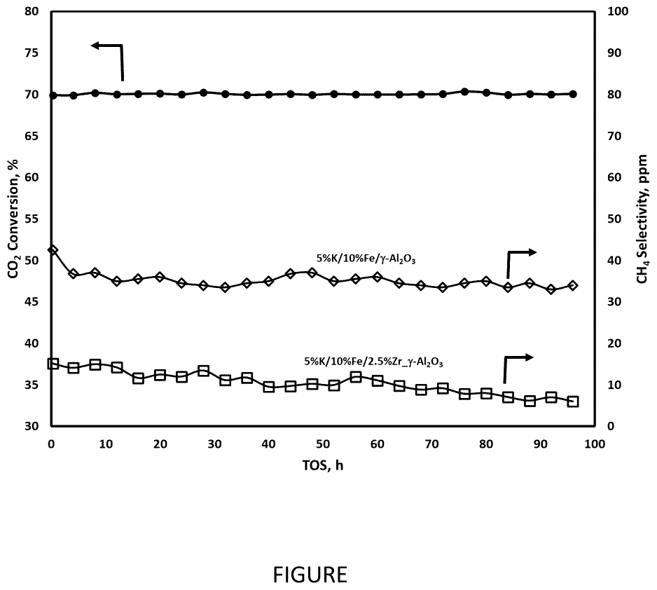

### FIELD OF THE DISCLOSURE

The present disclosure relates generally to catalyst compositions capable of converting carbon dioxide to carbon monoxide and the methods of making the catalysts.

### BACKGROUND OF THE DISCLOSURE

The catalytic reduction of carbon dioxide (CO₂) into other products is a compelling solution for CO₂ mitigation. The reverse water gas shift (RWGS) reaction plays a pivotal role among the various CO₂ utilization approaches because it can be used to produce carbon monoxide (CO), and when using excess hydrogen, the reverse water gas shift reaction produces synthesis gas or syngas: a mixture of hydrogen (H₂) and CO. Syngas is a building block of numerous conversion processes frequently used in industrial refineries for Fischer-Tropsch synthesis or production of alcohols, such as methanol, which is one of the top five chemicals sold worldwide. The growing demand for clean fuels and commodities reinforces the significance of highly efficient RWGS processes coupled to CO₂ revalorization. Furthermore, reactors for the reaction RWGS can be advantageously implemented with the current infrastructure in any heavy carbon industry (e.g., cement, steel making, refineries, etc.).

The reverse water gas shift reaction is an equilibrium reaction favored at high temperatures due to its moderately endothermic character, as well as at high H₂:CO₂ feed ratios, low pressure and lower contact times. Since the reverse water gas shift reaction is an equilibrium reaction, the reaction may convert CO₂ into carbon monoxide and methane (CH₄). The conversion of CO₂ to methane is called methanation, and it may occur through a consecutive reaction pathway where the RWGS is the first step. During the RWGS reaction, the formed CO may undergo hydrogenation reaction to produce methane, which is a facial and energetically favorable reaction because of the higher reactivity of the CO molecule. Hence, CO₂ methanation is considered to be the main side reaction affecting the RWGS process selectivity.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to embodiments of the present disclosure includes catalysts that include a zirconium doped aluminum support, the zirconium being present in 0.5 wt % to 4 wt % based on the weight of the support, 3 wt % to 20 wt % iron, the weight percent being based on the combined weight of the zirconium doped support and the iron; and 1 wt % to 10 wt % alkali metal, the weight percent being based on the total weight of the catalyst. Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The FIGURE is a graph of the CO₂ conversion percent and methane selectivity (ppm) as a function of time on stream (TOS) for catalyst 5% K/10% Fe/2.5% Zr_γ-Al₂O₃ and the comparative catalyst 5% K/10% Fe/γ-Al₂O₃

### DETAILED DESCRIPTION

Embodiments of the present disclosure will now be described in detail with reference to the accompanying FIGURES. Like elements in the various FIGURES may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying FIGURES may vary without departing from the scope of the present disclosure.

The present disclosure relates generally to catalyst compositions capable of converting carbon dioxide to carbon monoxide and the methods of making the catalysts.

As previously described, RWGS reaction produced CO, and the produced CO may undergo hydrogenation reaction to produce methane, which is a facial and energetically favorable reaction because of the higher reactivity of the CO molecule. Therefore, ongoing needs exist to design effective catalysts for the selective formation of CO via the reverse water gas shift reaction. The catalysts' acidity is the main physicochemical property responsible for the excessive hydrogenation of CO₂ to form methane, therefore, the acidity of the catalyst of this disclosure is controlled, which decreases the formation of methane. The catalyst of this disclosure is capable of hydrogenating CO₂ to produce CO with selectivity greater than 99.99% at reaction temperature of 923 K or higher and CO₂:H₂ feed ratio of 1 or higher.

In particular, the catalyst consisting in its active form of a mixture of iron oxide supported on γ-alumina. Both the iron oxide and γ-alumina are known to exhibit sufficient acidity to catalyze the hydrogenation of CO₂ to form significant amounts of methane. Addition of alkali metal components to metal oxides such as iron-oxide and γ-alumina is known to be effective in reducing their acidity. In particular, heavy Alkali metals such as potassium and cesium are preferably used because of their lower tendency to acquire mobility than lithium or sodium under hydrothermal conditions prevalent during the RWGS reaction and the catalyst regeneration protocol. The addition of zirconia to the γ-alumina is also known to limit the acidity of the alumina support with greater stability than that of alkali metals under hydrothermal conditions. Therefore, the addition of zirconium as well as alkali-metal component to the preparation of the catalyst in this invention allowed for the necessary modification of the catalysts' acidity to obtain the desired performance and selectivity described in the invention.

Embodiments of the present disclosure includes catalysts that include a zirconium doped aluminum support, the zirconium being present in 0.5 wt % to 4 wt % based on the weight of the support, 3 wt % to 20 wt % iron, the weight percent being based on the combined weight of the zirconium doped support and the iron; and 1 wt % to 10 wt % alkali metal, the weight percent being based on the total weight of the catalyst.

In one or more embodiments, the zirconium is present in amount of 1.0 wt % to 3.0 wt %, or the zirconium is present in amount of 1.25 wt % to 2.5 wt %.

In various embodiments, the catalyst includes about 4 wt % to about 16 wt % iron, based on the weight of the zirconium doped support. In some embodiments, the catalyst includes about 5 wt % to about 10 wt % iron, based on the weight of the zirconium doped support.

The catalyst may include from about 1 wt % to about 6 wt % alkali metal, based on the weight of the catalyst. In some embodiments, the alkali metal comprises potassium, sodium, lithium cesium, rubidium, or combinations thereof. In one or more embodiments, alkali metal is potassium. Starting materials of the alkali metals may include, in non-limiting example, salts of the alkali metal such as alkali nitrates, alkali acetates, alkali carbonates, alkali sulfates, and combinations thereof.

The catalyst of this disclosure may not include Nobel metals, such as platinum or palladium. The catalyst does not include platinum, palladium, nickel, ruthenium, chromium, copper, manganese, or silver.

The iron in the catalyst may be derived from iron salt. The iron salt may include iron sulfate, iron chloride, iron acetate, iron nitrate or iron acetylacetonate. The alkali metal could be potassium nitrate, potassium chloride, potassium bicarbonate, rubidium nitrate, rubidium chloride, cesium nitrate, cesium chloride, potassium benzoate, potassium acetylacetonate, potassium acetylide, or potassium acetylamino succinate. The source of zirconium include zirconyl nitrate, zirconyl chloride or zirconyl acetylacetonate.

The catalyst support includes zirconium introduced by pore-volume impregnation of the γ-alumina. It may be present as crystalline zirconium oxide (zirconia, ZrO₂). The addition of zirconium onto the aluminum support forms the mixed ZrO₂—Al₂O₃ solid support. The alumina may be γ-alumina, which may be obtained commercially.

Methods of making a catalyst include doping an aluminum support with 0.5 wt % to 4 wt % of zirconium, the weight percent based on the weight of the support, to form a zirconium-aluminum (Zr—Al) support. Iron is deposited onto the Zr—Al support to form an iron supported precursor; impregnating the iron supported precursor with an alkali metal to form a pre-catalyst. The pre-catalyst includes 5 wt % to 20 wt % iron, the weight percent based on the total weight of the catalyst; 3 wt % to 10 wt % alkali metal, the weight percent based on the total weight of the catalyst; and a zirconium doped aluminum support, the zirconium being present in 0.5 wt % to 4 wt % based on the weight of the support. The pre-catalyst is calcined to produce the catalyst.

The iron and alkali metal may be incorporated onto the zirconium doped aluminum support using means and methods that are well known to those skilled in the art. Such may include, for example, incipient wetness impregnation of an aqueous solution containing an iron salt and an alkali metal salt, with each impregnation followed by drying at, e.g., 120° C. The iron and alkali metal will be deposited onto the support. Other suitable means of depositing the iron onto the support may include wet impregnation, chemical vapor deposition, homogenous deposition precipitation, and any other technique known to those skilled in the art. Regardless of method, however, it is important to note that such should include a thermal treatment, e.g., a calcination, which operates to substantially decompose the iron and alkali compound to form oxide species.

Methods of converting CO₂ into CO includes obtaining a catalyst as described in the present disclosure. The catalyst is calcined at a calcining temperature of about 400° C. to about 600° C. under inert gas and atmospheric pressure. Then feed comprising CO₂ and hydrogen gas are fed into a reactor at a reactor temperature of 600° C. to 800° C., where the CO₂ and hydrogen gas are in contact with the catalyst. The CO₂ and hydrogen gas react with the catalyst to produce CO and methane, and the produced CO is separated from produced methane.

In some embodiments, the pre-catalyst is calcined under the flow of an inert gas at about 723 K to about 823 K (about 450° C. to about 550° C.) for about 3 to about 5 hours.

The methods of converting CO₂ to CO may be reacted in a fixed-bed reactor, an axial flow fixed bed reactor, a single tubular or multi-tubular reactor, or a radial flow fixed bed reactor.

The reaction temperature may be from about 923 K (650° C.) to about 1123 K (850° C.). The reaction temperature may be from about 923 K to about 1023 K. The reaction may be under atmospheric pressure, with gas-hour-space-velocity (GHSV) in the range 3300-13200 per hour. The feed ratio of CO₂ and hydrogen gas may be from 1:(1-5). The feed gas may further comprise unreacted hydrocarbon in the form of methane, and carbon monoxide.

In some embodiments, the reaction may include a reaction pressure of 0.1 MPa to 3 MPa.

The methods may produce products comprising CO, water, unreacted CO₂ and unreacted H₂, and methane. The water by-product is removed from the reactor product stream by condensation in a condenser operating at 273 k prior to feeding the product stream to gas chromatography for analysis. The unreacted CO₂ and hydrogen can be recycled, or the unreacted CO₂ can be separated from the product stream and recycled back into the reactor while the unreacted hydrogen and the produced CO are used in other processes such as Fischer-Tropsch synthesis or alcohol synthesis.

The methods to convert CO₂ to CO as presented in this disclosure produce comparatively low amounts of methane when compared to catalysts that lack the zirconium doped aluminum support. In some embodiments, the produced methane is less than 50 parts per million at the CO₂ hydrogen gas feed ratio of 1:5 and at the reactor temperature of 1023 K.

The feed may have minor impurities such as: methane, ethane, propane, oxygenates, and nitrogen oxides. However, as previously mentioned, the amount of impurities are very minor.

### EXAMPLES

### Example-1: Synthesis of 5% K/10% Fe/2.5% Zr—Al₂O₃

10.0 grams of γ-alumina (γ-Al₂O₃, Alfa Aesar, Surface area 80-102 metter² gram⁻¹) was loaded with 2.5 weight % zirconium (Zr) using pore-volume wetness impregnation where 0.775 grams of Zirconyl Nitrate (ZrO(NO₃)₂·2H₂O, Wako, 97%) dissolved in 20 milliliter deionized water was added to the solid alumina at once, mixed until a homogenous paste was obtained, and dried at 120° C. for 24 hours. The dried sample was calcined at 823K k for 5 hours in static air.

The zirconia-alumina powder was loaded with 10 weight % iron (Fe) by deposition-precipitation where 10.0 grams of the zirconia-alumina was dispersed in 50 milliliter deionized water followed by the addition of 8.20 g of iron nitrate (Fe(NO₃)₃·9H₂O, ACROS Organics, 98%) dissolved in 50 milliliters deionized water. The pH of the dispersion was then raised from 2.45 to 7.00-8.00 by the dropwise addition of 5.0-6.0 milliliters of ammonium hydroxide solution (NH₄OH, Aldrich, 32%) under vigorous stirring. The solid precipitate was separated from the mother-liquor by filtration using conventional filter paper on a funnel, washed with 100 milliliter de-ionized water three times while on the filter, and allowed to dry on filter at room temperature then at 373 k for 24 hours. The dried sample was calcined at 823K k for 5 hours in static air.

The solid zirconia-alumina supported iron powder was loaded with 5 weight % potassium (K) by wetness-impregnation where 10.0 grams of the solid was mixed with 1.36 grams potassium nitrate (KNO₃, Aldrich, 99%) dissolved in 50 milliliters deionized water. The solid was dried by removing the water using rotary-evaporation. The solid was then dried 373 k for 24 hours before calcining at 823K k for 5 hours in static air.

### Example-2: Synthesis of 5% K/10% Fe/1.25% Zr—Al₂O₃

10.0 grams of γ-alumina (γ-Al₂O₃, Alfa Aesar, Surface area 80-102 metter² gram⁻¹) was loaded with 1.25 weight % zirconium (Zr) using pore-volume wetness impregnation where 0.379 grams of Zirconyl Nitrate (ZrO(NO₃)₂·2H₂O, Wako, 97%) dissolved in 20 milliliter deionized water was added to the solid alumina at once, mixed until a homogenous paste was obtained, and dried at 120° C. for 24 hours. The dried sample was calcined at 823K for 5 hours in static air.

The zirconia-alumina powder was loaded with 10 weight % iron (Fe) by deposition-precipitation where 10.0 grams of the zirconia-alumina was dispersed in 50 milliliter deionized water followed by the addition of 8.20 g of iron nitrate (Fe(NO₃)₃·9H₂O, ACROS Organics, 98%) dissolved in 50 milliliters deionized water. The pH of the dispersion was then raised from 2.45 to 7.00-8.00 by the dropwise addition of 5.0-6.0 milliliters of ammonium hydroxide solution (NH₄OH, Aldrich, 32%) under vigorous stirring. The solid precipitate was separated from the mother-liquor by filtration using conventional filter paper on a funnel, washed with 100 milliliter de-ionized water three times while on the filter, and allowed to dry on filter at room temperature then at 373 k for 24 hours. The dried sample was calcined at 823K k for 5 hours in static air.

The solid zirconia-alumina supported iron powder was loaded with 5 weight % potassium (K) by wetness-impregnation where 10.0 grams of the solid was mixed with 1.36 grams potassium nitrate (KNO₃, 99%, Aldrich) dissolved in 50 milliliters deionized water. The solid was dried by removing the water using rotary-evaporation. The solid was then dried 373 k for 24 hours before calcining at 823K k for 5 hours in static air.

The solid zirconia-alumina supported iron powder was loaded with 5 weight % potassium (K) by wetness-impregnation where 10.0 grams of the solid was mixed with 1.36 grams potassium nitrate (KNO₃, Aldrich, 99%) dissolved in 50 milliliters deionized water. The solid was dried by removing the water using rotary-evaporation. The solid was then dried 373 k for 24 hours before calcining at 823K k for 5 hours in static air.

### Example-3: Synthesis of Comparative 5% K/10% Fe/γ-Al₂O₃

γ-alumina (γ-Al₂O₃, Alfa Aesar, Surface area 80-102 metter² gram⁻¹) powder was loaded with 10 weight % iron (Fe) by deposition-precipitation where 10.0 grams of the γ-alumina was dispersed in 50 milliliter deionized water followed by the addition of 8.20 g of iron nitrate (Fe(NO₃)₃·9H₂O, ACROS Organics, 98%) dissolved in 50 milliliters deionized water. The pH of the dispersion was then raised from 2.45 to 7.00 by the dropwise addition of 5.0 milliliters of ammonium hydroxide solution (NH₄OH, Aldrich, 32%) under vigorous stirring. The solid precipitate was separated from the mother-liquor by filtration using conventional filter paper on a funnel, washed with 100 milliliter de-ionized water three times while on the filter, and allowed to dry on filter at room temperature then at 373 k for 24 hours. The dried sample was calcined at 823K k for 5 hours in static air.

The solid γ-alumina supported iron powder was loaded with 5 weight % potassium (K) by wetness-impregnation where 10.0 grams of the solid was mixed with 1.36 grams potassium nitrate (KNO₃, Aldrich, 99%) dissolved in 50 milliliters deionized water. The solid was dried by removing the water using rotary-evaporation. The solid was then dried 373 k for 24 hours before calcining at 823K k for 5 hours in static air.

### Example-4: Catalyst Preparation and Activation

The catalysts as prepared in examples were pressed at 8 tones pressure to form tablets and crushed and sieved to form 200-500 micrometer granules. The granules (approx. 1.5 cm³, 0.50 grams) were packed into a tubular Quartz reactor which was 310 mm in length and 9.1 mm internal diameter. The reactor had a thermocouple immersed into the catalyst bed.

Argon gas (approx. 75 cm³/min) was passed over the catalyst and the reactor's temperature was increased to 923 k at the rate of 5 k/min and kept at 923 k for at least 1 hour. The temperature was then changed to the selected reaction temperature at a rate of 5 k/min.

### Example-5: Catalyst Testing

The activated catalysts as described above were tested for the hydrogenation of carbon dioxide through the reverse water gas shift (RWGS) reaction in a continuous flow fixed-bed reactor. The reaction was carried out at temperatures of 923 K and 1023 K, over 0.5 g of catalyst, under atmospheric pressure, a H₂ to CO₂ feed ratio ranging from 1 to 5, and a GHSV of 6600 milliliters (gram cat.)⁻¹ hour⁻¹. Tables 1-3 list the obtained CO₂ conversion values, methane selectivity, and selectivity for CO formation over the example catalysts. As seen in the Tables, over all three example catalysts; CO₂ conversion increases with increasing H₂:CO₂ ratio in the feed stream and with increasing reaction temperatures. While selectivity for CO formation increases with increasing reaction temperatures and decreasing H₂:CO₂ ratio in the feed stream. And with practically the same extent of CO₂ conversion, the selectivity for methane formation is found to decrease with the amount of zirconium added. This is a clear and unequivocal indication of the effect of zirconium in reducing the acidity of the catalyst which is the main driver for the secondary hydrogenation reaction of CO to form methane, an unwanted byproduct.

Table 1 includes the reaction conditions and the products and percentages of the products produced from the comparative example, Example 3.

TABLE 1
Values of the RWGS reaction over the catalyst of Example 3 - Comparative

| | 5% K/10% Fe/γ-Al₂O₃ | | | | | |
|---|---|---|---|---|---|---|
| | Reaction Temperature, 923 K (650° C.) | | | Reaction Temperature, 1023 K (750° C.) | | |
| | CO₂ | Methane | CO | CO₂ | Methane | CO |
| Feed | Conversion, | Selectivity, | Selectivity, | Conversion, | Selectivity, | Selectivity, |
| Composition | (%) | (ppm) | (%) | (%) | (ppm) | (%) |
| CO₂:1H₂ | 39.64 | 17 | 99.998 | 45.53 | 5 | 99.999 |
| CO₂:2H₂ | 54.40 | 36 | 99.996 | 61.47 | 19 | 99.998 |
| CO₂:3H₂ | 62.96 | 58 | 99.994 | 70.07 | 35 | 99.996 |
| CO₂:4H₂ | 68.80 | 78 | 99.992 | 75.63 | 51 | 99.995 |
| CO₂:5H₂ | 73.02 | 96 | 99.990 | 79.49 | 67 | 99.993 |

The catalyst of Example 3 does not include a zirconium doped aluminum support. The amount of methane produced increases as the ratio of CO₂ to hydrogen gas increases, thus the CO selectivity of the catalyst decreases.

In Table 2, the amount of the reaction products from the catalyst of Example 2 are recorded.

TABLE 2
Values of the RWGS reaction over the catalyst Example 2

| | 5% K/10% Fe/1.25% Zr_γ-Al₂O₃ | | | | | |
|---|---|---|---|---|---|---|
| | Reaction Temperature, 923 K | | | Reaction Temperature, 1023 K | | |
| | CO₂ | Methane | CO | CO₂ | Methane | CO |
| Feed | Conversion, | Selectivity, | Selectivity, | Conversion, | Selectivity, | Selectivity, |
| Composition | (%) | (ppm) | (%) | (%) | (ppm) | (%) |
| CO₂:1H₂ | 39.85 | 6 | 99.999 | 45.59 | 5 | 99.999 |
| CO₂:2H₂ | 54.50 | 24 | 99.998 | 61.52 | 13 | 99.999 |
| CO₂:3H₂ | 63.06 | 44 | 99.996 | 70.19 | 21 | 99.998 |
| CO₂:4H₂ | 68.81 | 59 | 99.994 | 75.73 | 32 | 99.997 |
| CO₂:5H₂ | 72.98 | 75 | 99.992 | 79.57 | 41 | 99.996 |

The catalyst of Example 2 includes 1.25% of zirconium in the support. The catalyst of Example 2 produced less amounts of methane than the comparative catalyst of Example 3, and the CO selectivity was higher when the feed ratio of CO₂/H₂ was 1:5 at temperatures of 923 K and 1023 K.

TABLE 3
Values of the RWGS reaction over the catalyst of Example 1

| | 5% K/10% Fe/2.5% Zr_γ-Al₂O₃ | | | | | |
|---|---|---|---|---|---|---|
| | Reaction Temperature, 923 K | | | Reaction Temperature, 1023 K | | |
| | CO₂ | Methane | CO | CO₂ | Methane | CO |
| Feed | Conversion, | Selectivity, | Selectivity, | Conversion, | Selectivity, | Selectivity, |
| Composition | (%) | (ppm) | (%) | (%) | (ppm) | (%) |
| CO₂:1H₂ | 40.15 | 3 | 100.00 | 45.40 | 2 | 100.00 |
| CO₂:2H₂ | 54.72 | 17 | 99.998 | 61.33 | 9 | 99.999 |
| CO₂:3H₂ | 63.23 | 24 | 99.998 | 70.01 | 13 | 99.999 |
| CO₂:4H₂ | 68.94 | 37 | 99.996 | 75.57 | 19 | 99.998 |
| CO₂:5H₂ | 73.16 | 40 | 99.996 | 79.47 | 23 | 99.998 |

The catalyst of Example 1 includes 2.5% of zirconium in the support. The catalyst of Example 3 produced less amounts of methane than the comparative catalyst of Example 3 and the catalyst of Example 2, and the CO selectivity was higher when the feed ratio of CO₂/H₂ was 1:5 at temperatures of 923 K and 1023 K.

Extended catalyst activity and stability test was performed for approximately 96 hours runs on catalysts of Examples 1 and 3 at a reaction temperature of 1023 K, over 0.5 g of catalyst, under atmospheric pressure, with a H₂ to CO₂ feed ratio of 3, and a GHSV of 6600 milliliters (gram cat.)⁻¹ hour⁻¹.

The data in the FIGURE showed stable CO₂ conversion over both catalysts with nearly identical values was obtained throughout the duration of the reaction. However, the selectivity for methane formation after approximately 96 hours was almost seven times less when the catalyst of Example 1 was compared to the catalyst of Example 3. This data indicates that the effect of zirconium doped aluminum support may decrease the catalyst's selectivity for methane formation, thereby producing a greater amount of carbon monoxide.

### Claims Bank for Foreign Filing

Embodiments disclosed herein include:

A. [A catalyst comprising a zirconium doped aluminum support, the zirconium being present in 0.5 wt % to 4 wt % based on the weight of the support, 3 wt % to 20 wt % iron, the weight percent being based on the combined weight of the zirconium doped support and the iron; and 1 wt % to 10 wt % alkali metal, the weight percent being based on the total weight of the catalyst.]

B. [A method of making a catalyst comprising: doping an aluminum support with 0.5 wt % to 4 wt % of zirconium, the weight percent based on the weight of the support, to form a Zr—Al support; depositing iron onto the Zr—Al support to form an iron supported precursor; impregnating the iron supported precursor with an alkali metal to form a pre-catalyst; wherein the pre-catalyst comprises: 5 wt % to 20 wt % iron, the weight percent based on the total weight of the catalyst; 3 wt % to 10 wt % alkali metal, the weight percent based on the total weight of the catalyst; and a zirconium doped aluminum support, the zirconium being present in 0.5 wt % to 4 wt % based on the weight of the support; and calcining the pre-catalyst.]

C. [A method of convert CO₂ into CO comprising: obtaining a catalyst of embodiment A; calcining the catalyst at a calcining temperature of about 400° C. to about 600° C. under inert gas and atmospheric pressure to produce a calcined catalyst; feeding the calcined catalyst and a feed gas comprising CO₂ and hydrogen gas into a reactor at a reactor temperature of 600° C. to 800° C.; and separating produced CO from produced methane.]

Each of embodiment of A through C may have one or more of the following additional elements in any combination: Element 1: [wherein the zirconium is present in amount of 1.0 wt % to 3.0 wt %]. Element 2: [wherein the zirconium is present in amount of 1.5 wt % to 2.5 wt %]. Element 3: [wherein the catalyst comprises 4 wt % to 16 wt % iron, based on the weight of the zirconium doped support]. Element 4: [wherein the catalyst comprises 5 wt % to 10 wt % iron, based on the weight of the zirconium doped support]. Element 5 [wherein the catalyst comprises 1 wt % to 6 wt % alkali metal, based on the weight of the catalyst]. Element 6 [wherein the catalyst does not comprise platinum]. Element 7 [wherein the alkali metal comprises potassium, sodium, lithium cesium, or rubidium.]. Element 8 [wherein feed gas comprises a ratio of CO₂ to hydrogen gas of 1:(1-5).]. Element 9 [wherein the produced methane is less than 50 parts per million at the CO₂ hydrogen gas feed ratio of 1:5 and at the reactor temperature of 1023 K].

By way of non-limiting example, exemplary combinations applicable to A through C include: Element 1 with Element 2; Element 2 with Element 3; Element 3 with Element 4; Element 2 with Element 5; Element 1 with Element 6; Element 7 with Element 8; Element 9 with Element 10; Element 10 with Element 11; Element 10 with Element 12; and Element 10 with Element 13 . . . .

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A catalyst comprising:
a zirconium doped aluminum support, the zirconium being present in 0.5 wt % to 4 wt % based on the weight of the support.
3 wt % to 20 wt % iron, the weight percent being based on the combined weight of the zirconium doped support and the iron; and
1 wt % to 10 wt % alkali metal, the weight percent being based on the total weight of the catalyst.

2. The catalyst of claim 1, wherein the zirconium is present in amount of 1.0 wt % to 3.0 wt %.

3. The catalyst of claim 1, wherein the zirconium is present in amount of 1.5 wt % to 2.5 wt %.

4. The catalyst of claim 1, wherein the catalyst comprises 4 wt % to 16 wt % iron, based on the weight of the zirconium doped support.

5. The catalyst of claim 1, wherein the catalyst comprises 5 wt % to 10 wt % iron, based on the weight of the zirconium doped support.

6. The catalyst of claim 1, wherein the catalyst comprises 1 wt % to 6 wt % alkali metal, based on the weight of the catalyst.

7. The catalyst of claim 1, wherein the catalyst does not comprise platinum.

8. The catalyst of claim 1, wherein the alkali metal comprises potassium, sodium, lithium cesium, or rubidium.

9. A method of making a catalyst comprising:
doping an aluminum support with 0.5 wt % to 4 wt % of zirconium, the weight percent based on the weight of the support, to form a Zr—Al support;
depositing iron onto the Zr—Al support to form an iron supported precursor;
impregnating the iron supported precursor with an alkali metal to form a pre-catalyst;
wherein the pre-catalyst comprises:
5 wt % to 20 wt % iron, the weight percent based on the total weight of the catalyst;
3 wt % to 10 wt % alkali metal, the weight percent based on the total weight of the catalyst; and
a zirconium doped aluminum support, the zirconium being present in 0.5 wt % to 4 wt % based on the weight of the support; and
calcining the pre-catalyst.

10. The catalyst of claim 9, wherein the zirconium is present in amount of 1.0 wt % to 3.0 wt %.

11. The catalyst of claim 9, wherein the zirconium is present in amount of 1.5 wt % to 2.5 wt %.

12. The catalyst of claim 9, wherein the alkali metal is potassium.

13. The catalyst of claim 9, wherein the catalyst comprises 5 wt % to 10 wt % iron, based on the wight of the zirconium doped support.

14. The catalyst of claim 9, wherein the catalyst comprises 1 wt % to 6 wt % alkali metal, based on the weight of the catalyst.

15. The catalyst of claim 9, wherein the catalyst does not contain platinum.

16. The catalyst of claim 9, wherein the alkali metal comprises potassium, sodium, lithium cesium, or rubidium.

17. A method of convert CO₂ into CO comprising:
obtaining a catalyst of claim 1;
calcining the catalyst at a calcining temperature of about 400° C. to about 600° C. under inert gas and atmospheric pressure to produce a calcined catalyst;
feeding the calcined catalyst and a feed gas comprising CO₂ and hydrogen gas into a reactor at a reactor temperature of 600° C. to 800° C.; and,
separating produced CO from produced methane.

18. The method of claim 17, wherein feed gas comprises a ratio of CO₂ to hydrogen gas of 1:(1-5).

19. The method of claim 17, wherein the produced methane is less than 50 parts per million at the CO₂ hydrogen gas feed ratio of 1:5 and at the reactor temperature of 1023 K.
